(19) United States
(12) Patent Application Publication
(10) Pub. No.: US 2005/0061181 A1
(43) Pub. Date: Mar. 24, 2005

(54) Print carrier sheets with crimp-on edge clips

(76) Inventor: Roger Burton, Essex (GB)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/668,844

(22) Filed: Sep. 23, 2003

(51) Int. Cl. B41F 27/00

(52) U.S. Cl. 101/415.1

(57) ABSTRACT

A edge clip for attachment to a print carrier sheet. The edge clip includes a clip portion, typically having a J-bar shape, that is configured for removable interface with a lock-up device carried by a print roll, and a crimp fitting attached to the clip portion and configured to be crimped shut to secure a print carrier sheet to the edge clip. The edge clip is typically uniform in cross-section, elongated in a longitudinal direction, and formed from a continuous extrusion. A print carrier sheet may be constructed by attaching one or more of these edge clip the longitudinal edges of a backing. The print carrier sheet may then be attached to a print roll using a suitable a lock-up device to interface the crimp-on edge clips.

### TECHNICAL FIELD

The present invention relates to machines for printing corrugated board and, more particularly, relates to a print carrier sheet including one or more crimp-on edge clips for attaching the print carrier sheet to a print roll.

### BACKGROUND OF THE INVENTION

For many years, cylindrical print rolls have been used to print lettering and other images on sheets of corrugated board. To create the desired image, a printing die is first assembled and attached to a print carrier sheet, which is then attached to the print roll. As the print roll rotates, the printing machine applies ink to the printing die, which is transferred to the sheets of corrugated board as the sheets are conveyed through the printing machine and across the printing die. The carrier sheets are removable, so that they can be changed out for different jobs. In general, print carrier sheets carrying different dies are constructed as needed, and stored in a convenient location when not in use. Each print shop typically stores scores of printing dies for its various customers.

In a printing machine of this type, the print carrier sheet includes an edge clip, such as to as a conventional J-bar that attaches the print carrier sheet to a lock-up device on the print roll. For the well-known Matthews Fast Lock system, the print carrier sheet includes an edge clip on one end and a number of elastic straps on the other end. Other types of lock-up devices use full-wrap print carrier sheets that include an edge clip on each end of the carrier sheet. All of these lock-up systems use at least one edge clip that must be firmly attached to the print carrier sheet with the edge clip square to the edges of the print carrier sheet. Both of these conditions are quite important. If an edge clip should come lose from the carrier sheet, it could destroy an expensive printing die, anilox roll, or another component of the printing machine. In addition, the edge clip should be square to the edges to the print carrier sheet so that the sheet attaches to the print roll orthogonally from the edge clip for proper sheet alignment and die registration.

To meet these design objectives, edge clips have traditionally been manufactured from polymeric materials, such as plastic or NYLON®, and sewn to the print carrier sheet. Although this results in a strong bond, the attachment process is time consuming. In addition, relative movement between the edge clip and the carrier sheet can make it difficult to maintain the desired square positional relationship as the sewn seam moves across the edge clip during the sewing process. A slightly out-of-square edge clip can result in unevenness in the sheet tension when the sheet is tightened onto the print roll, which can cause the sheet to tear or stretch in an uneven manner. As a result, a continuing need exists for a faster, easier and less costly system for reliably attaching edge clips to print carrier sheets with the desired square positional relationship.

### SUMMARY OF THE INVENTION

The present invention meets the needs described above in a print carrier sheet including a crimp-on edge clip on one or both ends. The crimp-on edge clip is faster and easier to attach to the print carrier sheet than traditional sewn-on edge clips. In addition, the crimp-on edge clip is easy to install in a square positional relationship to the print carrier sheet because it can be crimped using a jig that maintains the desired square positional relationship while crimping the edge clip in place. The crimp-on edge clip is preferably manufactured as an aluminum extrusion, which is a cost effective way to produce large quantities of uniform edge clip. The invention may be practiced as a crimp-on edge clips for print carrier sheets, as a print carrier sheet carrying one or more crimp-on edge clips, as a print roll carrying a print carrier sheet that is attached using one or more crimp-on edge clips, and as a printing machine having a print roll carrying a print carrier sheet that is attached using one or more crimp-on edge clips. The invention may also be practiced as a method for attaching print carrier sheets to print rolls in a printing machine.

Generally described, the invention may be realized in an edge clip for attachment to a print carrier sheet. The edge clip includes a clip portion, typically having a J-bar shape, that is configured for removable interface with a lock-up device carried by a print roll. The edge clip also includes a crimp fitting attached to the clip portion and configured to be crimped shut to secure a print carrier sheet to the edge clip. The edge clip is typically uniform in cross-section, elongated in a longitudinal direction, and formed from a continuous extrusion. A print carrier sheet may be constructed by attaching one or more of these edge clips to the longitudinal edges of a backing. The print carrier sheet may then be attached to a print roll using a suitable a lock-up device to interface with the crimp-on edge clips.

More specifically, the invention may be practiced as a printing machine that includes a cylindrical print roll extending in a longitudinal direction along an axis of rotation. A lock-up device carried by the print roll includes first and second rails extending in the longitudinally direction. A print carrier sheet is held to the print roll by the lock-up device. This print carrier sheet includes a backing having first and second longitudinal edges, a first edge clip crimped to the first edge and removably interfaced with a first rail of the lock-up device, and a second edge clip crimped to the second edge and removably interfaced with a second rail of the lock-up device. Each edge clip is typically uniform in cross-section, elongated in the longitudinal direction, and formed from a continuous extrusion.

The invention may also be practiced as a method for implementing crimp-on edge clips for a print carrier sheet. This method includes providing a print carrier sheet backing having a longitudinal edge, and crimping an edge clip to the edge. The print carrier sheet backing may include a second longitudinal edge, and a second edge clip may be crimped to the second edge. The print carrier sheet may also be removably attached to a print roll in a printing machine, which may be used to print images using the print carrier sheet.

In view of the foregoing, it will be appreciated that the present invention provides a cost effective crimp-on edge clip for attaching print carrier sheets to print rolls in printing machines. The specific techniques and structures for implementing the crimp-on edge clip, and thereby accomplishing the advantages described above, will become apparent from the following detailed description of the embodiments and the appended drawings and claims.

### BRIEF DESCRIPTION OF THE DRAWINGS

FIG. 1 is a side view of a crimp-on edge clip before being crimped shut.

FIG. 2 is a side view of the crimp-on edge clip of FIG. 1 after it has been crimped shut along an edge of a print carrier sheet.

FIG. 3 is perspective view of a crimp-on edge clip for attaching a print carrier sheet to a print roll.

FIG. 4 is an end view of the edge clip of FIG. 3.

FIG. 5 is a bottom view of the edge clip of FIG. 3.

FIG. 6 is a top view of the edge clip of FIG. 3.

FIG. 7 is a front view of the edge clip of FIG. 3.

FIG. 8 is perspective view of an illustrative portion of a print carrier sheet including a crimp-on edge clip.

FIG. 9 is an end view of the print carrier sheet of FIG. 8.

FIG. 10 is a top view of the print carrier sheet of FIG. 9.

FIG. 11 is a front view of the print carrier sheet of FIG. 9.

FIG. 12 is a perspective view a print carrier sheet carrying crimp-on edge clips.

FIG. 13 is an end view of a print roll carrying a print carrier sheet with crimp-on edge clips, in which the print roll includes a lockup device for securing the carrier sheet to the print roll before the jaw has been tightened.

FIG. 14 is a side view of the FIG. 9 print roll after the jaw has been tightened.

FIG. 15 is a perspective view of a print roll carrying a print carrier sheet with crimp-on edge clips.

### DETAILED DESCRIPTION OF THE EMBODIMENTS

The crimp-on edge clip described below may be used to removably attach print carrier sheets to print rolls in any type of roller printing system, and particularly those using the anilox flexographic printing technology that has been used in the corrugated board industry for many years. The basic anilox flexographic printing technology has been deployed in a wide variety of printing machines, such as those described in commonly owned U.S. Pat. No. 6,557,465 entitled, “Printing Machine With Dual-Ink Applicators” dated May 6, 2003, and U.S. Pat. No. 6,062,751 entitled “Belt-Driven Printer-Cutter Machine For Corrugated Paperboard of Varying Thickness” dated May 16, 2002, which are incorporated herein by reference. In addition, a rack-and-pinion lock-up system may be used to attach print carrier sheets to print rolls in these machines or in any other roller printing machine that uses print rolls and print carrier sheets. See, for example, concurrently filed U.S. patent application Ser. No. ______ entitled “Rack-And-Pinion Lock-Up System For Attaching Print Carrier Sheets To Print Rolls,” which is also incorporated herein by reference.

The crimp-on edge clip typically has a uniform crosssection, such as a J-bar shape, which makes it suitable for large-volume production as an aluminum extrusion. This extrusion provides its most secure attachment to the print carrier sheet backing when the crimp fitting of the edge clip extends all or almost of the way across the longitudinal edge of the backing. However, it should be appreciated that the crimp fitting or the entire edge clip could be implemented as multiple segments along the longitudinal edge. Similarly, the clip portion of the edge clip that removably attaches to the lock-up device on the print roll typically extends all or almost of the way across the longitudinal edge of the backing. Again, however, the clip portion could be implemented as multiple segments along the longitudinal edge.

Nevertheless, it should be appreciated that the continuous edge clip with uniform crosssection extending all or almost all of the way across the across the longitudinal edge of the backing is preferred to minimize the likelihood that an edge clip may come lose from the print carrier sheet. The continuous edge clip with uniform crosssection is also easy and inexpensive to manufacture as an extrusion, and easy to install in a square positional relationship with respect to the print carrier sheet. In addition, although the clip portion of the edge clip typically has the shape of a conventional J-bar, this is a design choice that may be altered as desired, for example to accommodate a lock-up device that is configured to receive an edge clip with a different shape.

To increase the security of the attachment between the edge clip and the print carrier sheet, one or more screws, staples, pins or rivets may be inserted through the crimp fitting, and therefore through the backing material held within the crimp fitting, after the fitting has been crimped shut. Alternatively or additionally, the edge clip may be augmented to accommodate additional fasteners, for example by including additional eyelets, loops or a flange surface suitable for riveting, sewing, stapling, or otherwise securing the edge clip to the print carrier sheet backing. Although these additional features would increase the cost of the print carrier sheet, the additional security may be worth the investment for certain applications due to the high host of the printing dies, anilox rollers, or other machine components that could be damaged by a loose edge clip.

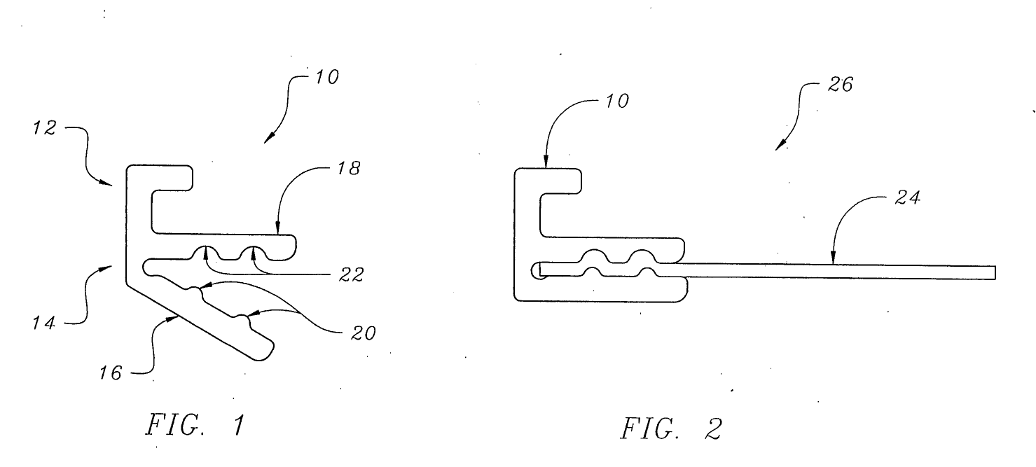

Turning now to the figures, in which like numerals refer to similar elements throughout the several figures, FIG. 1 is a side view of a crimp-on edge clip 10 before being crimped shut. Although the crimp-on edge clip 10 is typically formed as a continuously aluminum extrusion, any suitable material and method of manufacturing may be employed. The edge clip 10 includes a clip portion 12 having the shape of a conventional J-bar that is configured to removably interface with a rail or other suitable interface edge of a lock-up system carried on a print roll. The edge clip 10 also includes a crimp fitting 14 that is attached to the clip portion 12. The crimp fitting 14 includes a lower flange 16 and an upper flange 18. The lower flange 16 includes two protrusions 20 configured to fit within two corresponding channels 22 in the upper flange 18.

These protrusions 20 and corresponding channels 22 help the edge clip 10 to form a secure crimp joint with a material to which the clip is crimped. In particular, FIG. 2 is a side view of the edge clip 10 after it has been crimped shut along an edge of a backing material 24 to form an illustrative portion of a print carrier sheet 26. The backing material is typically a polymeric material, such as MYLAR®, PVC, polyester, or another material suitable for carrying a printing die. Of course, the print carrier sheet 26 may have any desired length, width and thickness suitable for receipt by the edge clip 10, and may also have a similar edge clip on an end opposing edge. Therefore, FIG. 2 should be understood to illustrate only the portion of the print carrier sheet 26 where the edge clip 10 attaches.

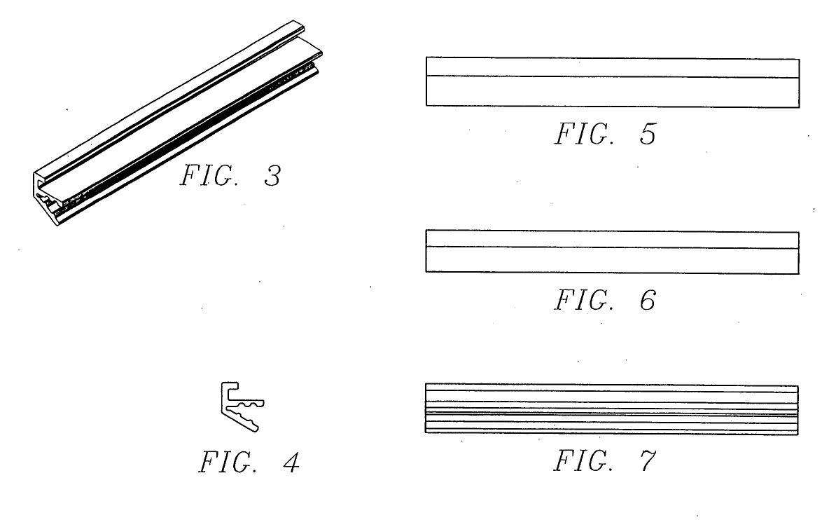

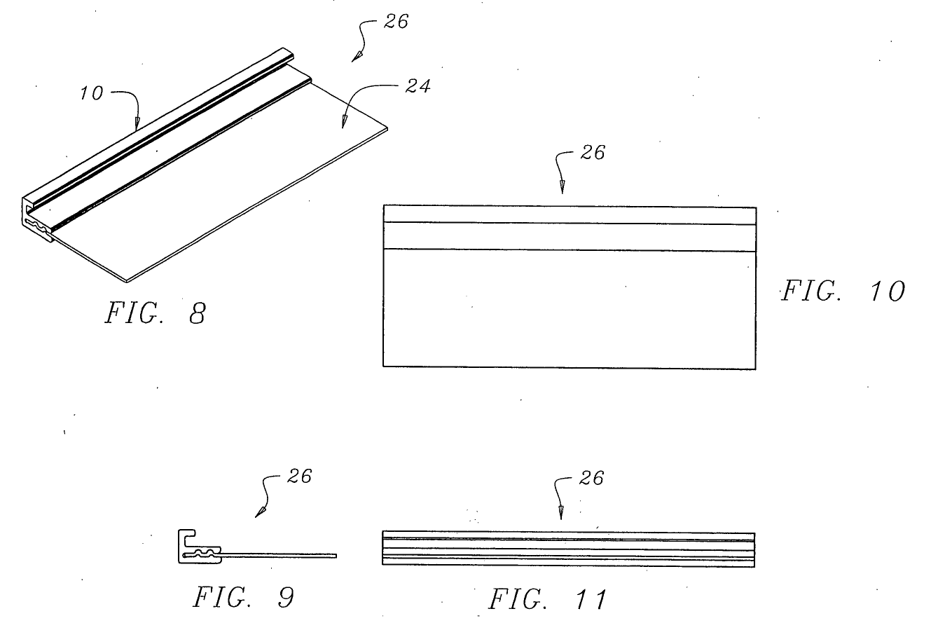

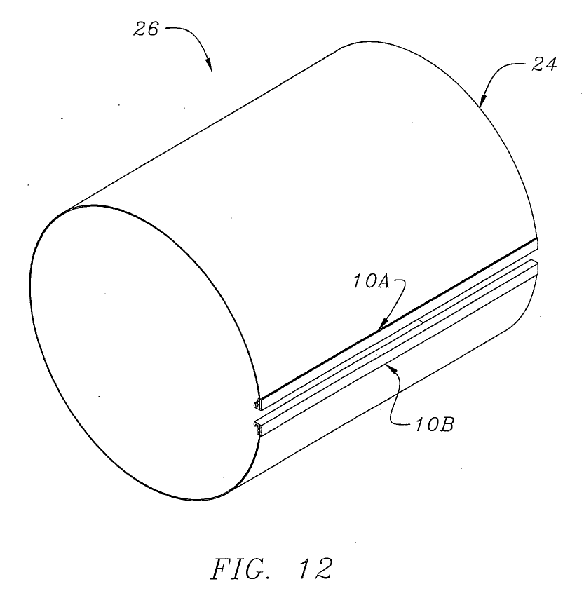

FIG. 3 is perspective view of the crimp-on edge clip 10, which may have any desired length. The particular length shown in FIG. 3 is only for illustrative convenience. FIG. 4 is an end view, FIG. 5 is a bottom view, FIG. 6 is a top view, and FIG. 7 is a front view of the edge clip 10. As shown in FIGS. 3-7, the edge clip 10 has a uniform crosssection and extends in a longitudinal direction to form a elongated, narrow crimp-on edge clip. FIG. 8 is a perspective view of the print carrier sheet 26 after the edge clip 10 has been crimp-on to an edge. FIG. 9 is an end view, FIG. 10 is a top view, and FIG. 11 is a front view of the print carrier sheet 26.

To install the edge clip 10 on the backing material 24, a jig may be placed adjacent to one side of a press to ensure that the edge clip 10 is crimped in a proper orthogonal positional relationship with respect to the print carrier sheet backing material 24. This jig typically includes a wall, bracket, guides, rollers or other suitable surface or system for supporting the side of the backing material 24 perpendicular to the press as the backing material is moved into the edge clip 10, which is held in place within the press. The press is then activated to crimp the edge clip 10 onto the print carrier sheet backing material 24 to form the print carrier sheet 26. The head of the press or the jig may be moved in the longitudinal direction to crimp the edge clip in several places. A full-wrap carrier sheet may be constructed by attaching a second edge clip to the opposing end of the print carrier sheet in a similar manner.

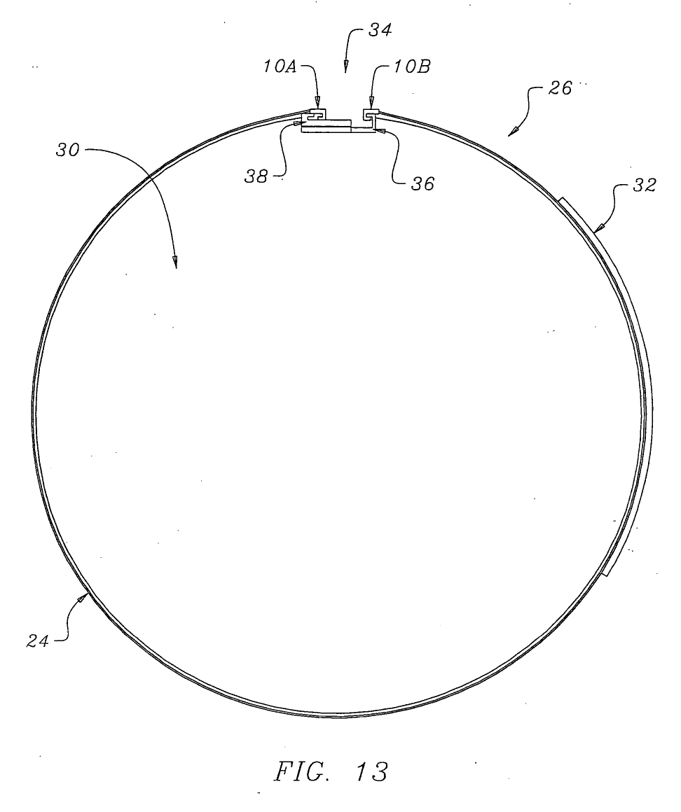

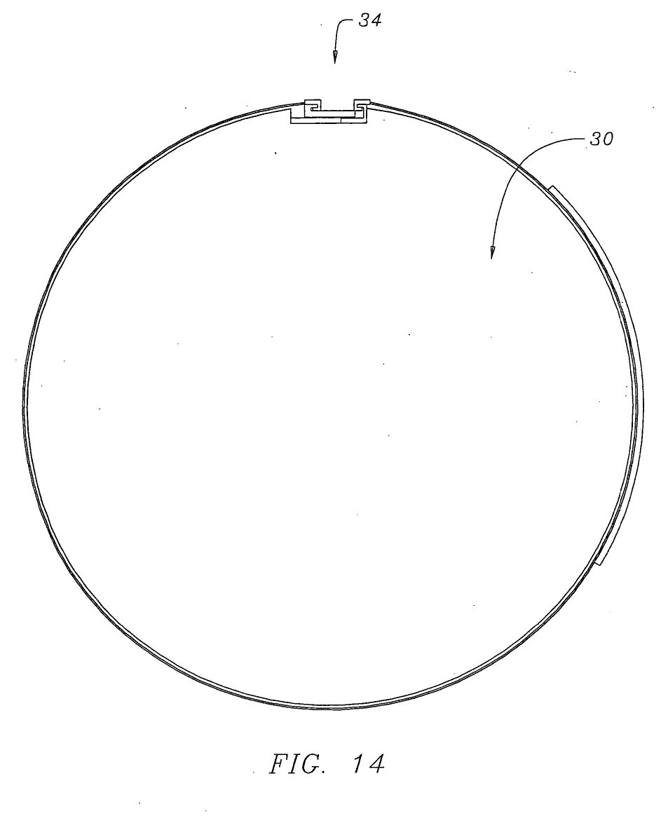

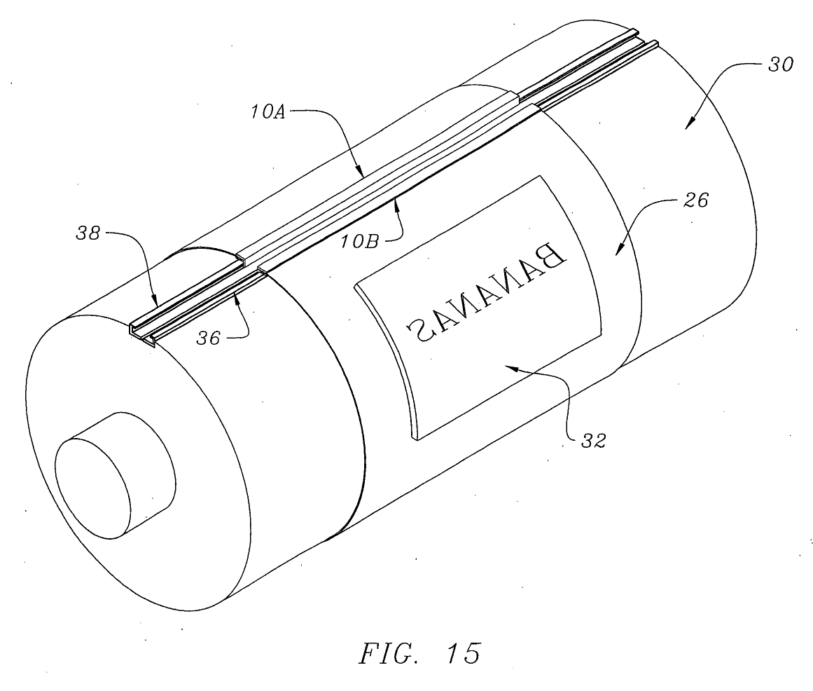

FIG. 12 is a perspective view a complete print carrier sheet 26 constructed in this manner, which includes a backing material 24 carrying a pair of crimp-on edge clips 10A-B on opposing edges. A print carrier sheet 26 in this configuration is suitable for carrying a printing die, and for being removably attached to a print roll. Specifically, FIG. 13 is an end view of a print roll 30 carrying a print carrier sheet 26 that includes crimp-on edge clips 10A-B and a printing die 32. This illustrative print roll includes a lock-up device 34 for securing the carrier sheet 26 to the print roll 30. The lock-up device 34 includes a stationary clip 36 and a locking clip 38 that can be moved toward and away from the stationary clip to form a jaw. FIG. 13 shows the lock-up device 34 before the jaw of the device has been tightened, and FIG. 14 shows the print roll 30 after the jaw has been tightened. FIG. 15 is a perspective view of the print roll 30 carrying the print carrier sheet 26 with the crimp-on edge clips 10A-B. In this particular embodiment, the print carrier sheet 26 is shown carrying a printing die 32 with the lettering “BANANAS” for illustrative purposes.

The edge clips 10A-B may be used to attach a print carrier sheet 26 to a print roll 30 in any type of roller printing system, such as an anilox flexographic printing machine. In particular, the print roll 30 may include a rack-and-pinion lock-up device 34 for attaching the print carrier sheet 26 sheet to the print roll 30. This type of lock-up device includes a stationary clip 36 and locking clip 38 that can selectively slide toward and away from the stationary clip to form a jaw extending almost entirely across the print roll 30 in its longitudinal direction. The rack-and-pinion mechanism 34 may typically be manually operated to open and close the jaw by sliding the locking clip 38 toward and away from the stationary clip 36. A suitable lock-up device is described in the concurrently filed United States patent application entitled Rack-And-Pinion Lock-Up System For Attaching Print Carrier Sheets To Print Rolls, which was previously introduced and incorporated by reference.

To operate this particular rack-and-pinion mechanism, a technician places a tool, such as an Allen wrench, into a drive socket. Turning the wrench turns a pinion gear, which drives the opening and closing movement of the jaw. The rack-and-pinion mechanism also includes a lock socket, typically operated with a screwdriver, which is used to lock the pinion gear in a desired position. As a convenience, a combination tool in an “L” shape with a properly sized Allen wrench on one end and a properly sized flat-head screwdriver on the other end may be used to operate the rack-and-pinion mechanism. This tool should be stored in a convenient location, such as attached to the end of a leash attached to the frame supporting the print roll.

To install the print carrier sheet 26 as shown in FIG. 15, the technician places the carrier sheet 26 on the print roll 30 with one edge clip 10A interfaced with the locking clip 38 and the second edge clip 10B interfaced with the stationary clip 36. The technician then places the screwdriver tool in the lock socket and turns the tool to unlock the rack-and-pinion mechanism 34. The technician then places the Allen wrench tool in the drive socket and turns the tool to slide the locking clip 38 toward the stationary clip 36 until the carrier sheet 26 has been sufficiently tightened on the print roll 30. The technician then once again places the screwdriver tool in the lock socket and turns the tool, this time in the opposite direction to lock the rack-and-pinion mechanism 34. The print roll 30 is now ready to run. The process is reversed to remove the carrier sheet 26.

It should be appreciated that the resulting print carrier sheet installation process is easy, quick and involves no loose straps or clips, as was the case with the older Matthews Fast Lock system. In addition, the hand-operated lock-up system reduces the chances of injury that might occur, for example, with a hydraulic or other powered jaw system. Furthermore, the print carrier sheet 26 is supported across the full length of its attachment longitudinally across the print roll 30, which ensures a consistent registration of the print image. And the carrier sheet 26 itself is not bent or rolled in sharp manner, which avoids cracking, wearing and undesirable curling of the sheet. Importantly, all of these advantages are achieved in a lock-up device with a minimum of moving parts, and which fits in a slot in the print roll 30 sized to hold the older, static lock-up of the Matthews Fast Lock system. Therefore, the rack-and-pinion lock-up system shown in FIG. 15 can be quickly and easily installed as a retrofit for an existing Matthews Fast Lock system, and the system may thereby be quickly and easily upgraded to accommodate the full-wrap print carrier sheets 26. To facilitate this type of retrofit application, a retrofit rack-and-pinion system may be sold with a drilling jig that includes a template to assist in proper location of the mounting holes to be drilled and tapped into the print roll. Properly sized drill bits and tapping dies may also be included to facilitate the retrofit installation.

In view of the foregoing, it will be appreciated that present invention provides significant improvements in carrier sheets that removably attach to print rolls in roller printing systems. It should be understood that the foregoing relates only to the exemplary embodiments of the present invention, and that numerous changes may be made therein without departing from the spirit and scope of the invention as defined by the following claims.

1. A crimp-on edge clip for attachment to a print carrier sheet, comprising:
a crimp fitting comprising an upper flange and a lower flange connected at an intersection and configured to be crimped shut to secure a print carrier sheet to the edge clip;
a clip portion integral with the crimp fitting and extending from the intersection of the upper flange with the lower flange: and
the edge clip forming a J-bar configured for removable interface with a lock-up device carried by a print roll.

2. (canceled)

3. The crimp-on edge clip of claim 1, wherein the edge clip is uniform in cross-section and elongated in a longitudinal direction.

4. The crimp-on edge clip of claim 3, consisting essentially of a continuous extrusion.

5. A print carrier sheet comprising:
a backing having first and second opposing edges extending in a longitudinal direction;
a first edge clip crimped to the first edge comprising a crimp fitting having an upper flange and a lower flange connected at an intersection and an integral clip portion extending from the intersection, the first edge clip forming a first J-bar;
a second edge clip crimped to the second edge comprising a crimp fitting having an upper flange and a lower flange connected at an intersection and an integral clip portion extending from the intersection, the second edge clip forming a second J-bar; and
the first and second J-bars configured for removable interface with opposing longitudinal rails of a lock-up device carried by a print roll.

6. (canceled)

7. (canceled)

8. The print carrier sheet of claim 5, wherein each edge clip is uniform in cross-section and elongated in the longitudinal direction.

9. The print carrier sheet of claim 8, wherein each edge clip consists essentially of a continuous extrusion.

10. A print roll extending in a longitudinal direction and carrying a carrier sheet comprising:
a lock-up device carried by the print roll and comprising first and second opposing rails extending in the longitudinal direction; and
a print carrier sheet held to the print roll by the lock-up device and comprising:
a backing having first and second opposing edges extending in the longitudinal direction;
a first edge clip crimped to the first edge comprising a crimp fitting having an upper flange and a lower flange connected at an intersection and an integral clip portion extending from the intersection, the first edge clip forming a first J-bar that is removably interfaced with the first rail of the lock-up device; and
a second edge clip crimped to the second edge comprising a crimp fitting having an upper flange and a lower flange connected at an intersection and an integral clip portion extending from the intersection, the second edge clip forming a second J-bar that is removably interfaced with the second rail of the lock-up device.

11. (canceled)

12. The print roll of claim 10, wherein each edge clip is uniform in cross-section and elongated in the longitudinal direction.

13. The print roll of claim 10, wherein each edge clip consists essentially of a continuous extrusion.

14. A printing machine, comprising:
a cylindrical print roll extending in a longitudinal direction along an axis of rotation;
a lock-up device carried by the print roll and comprising first and second rails extending in the longitudinal direction;
a print carrier sheet held to the print roll by the lock-up device and comprising:
a backing having first and second edges extending in the longitudinal direction;
a first edge clip crimped to the first edge comprising a crimp fitting having an upper flange and a lower flange connected at an intersection and an integral clip portion extending from the intersection, the first edge clip forming a first J-bar that is removably interfaced with the first rail of the lock-up device, and
a second edge clip crimped to the second edge comprising a crimp fitting having an upper flange and a lower flange connected at an intersection and an integral clip portion extending from the intersection, the second edge clip forming a second J-bar that is removably interfaced with the second rail of the lock-up device.

15. The printing machine sheet of claim 14, wherein each edge clip is uniform in cross-section and elongated in the longitudinal direction.

16. The printing machine of claim 15, wherein each edge clip consists essentially of a continuous extrusion.

17. A method for implementing crimp-on edge clips for a print carrier sheet, comprising the steps of:
providing a print carrier sheet backing having a first longitudinal edge;
providing a first edge clip that is uniform in cross-section and consists essentially of a continuous extrusion, the first edge clip comprising a crimp fitting having an upper flange and a lower flange connected at an intersection and an integral clip portion extending from the intersection, the first edge clip forming a first J-bar; and
crimping the first edge clip to the first longitudinal edge.

18. The method of claim 17, further comprising the steps of:
providing a second longitudinal edge on the print carrier sheet backing;
providing a second edge clip that is uniform in cross-section and consists essentially of a continuous extrusion, the second edge clip comprising a crimp fitting having an upper flange and a lower flange connected at an intersection and an integral clip portion extending from the intersection, the second edge clip forming a second J-bar; and
crimping the second edge clip to the second edge.

19. The method of claim 18, further comprising the step of removably attaching the print carrier sheet to a print roll in a printing machine.

20. The method of claim 19, further comprising the step of running the printing machine to print images using the print carrier sheet.
